(19) United States
(12) Patent Application Publication
(10) Pub. No.: US 2014/0083619 A1
(43) Pub. Date: Mar. 27, 2014

(54) MULTI BEAD TYPE GREENTIRE MANUFACTURING APPARATUS

(71) Applicant: WOOSUNG MACHINERY CO., LTD., Siheung (KR)

(72) Inventor: Gooyeon Hwang, Seoul (KR)

(73) Assignee: WOOSUNG MACHINERY CO., LTD., Siheung (KR)

(21) Appl. No.: 13/747,932

(22) Filed: Jan. 23, 2013

(30) Foreign Application Priority Data
Sep. 21, 2012 (KR) 10-2012-0105022

(51) Int. Cl. B29D 30/24

(52) U.S. Cl. CPC B29D 30/244
USPC 156/416

(57) ABSTRACT

Disclosed herein is a multi bead type greentire manufacturing apparatus. The apparatus includes a rubber plate made from a raw material of the greentire and mounted on a winding drum. Additionally, a plurality of gloves and bladders are formed separately to transform the rubber plate (91), thereby automating a manufacturing process of a large-scale greentire having multi-layer beads. The multi bead type greentire manufacturing apparatus increases the productivity of large sized greentires and reduces an error rate in forming the greentires by increasing forming accuracy.

### CROSS-REFERENCE TO RELATED APPLICATIONS

This application claims priority to Korean Application No. 10-2012-0105022 filed on Sep. 21, 2012, which is incorporated herein by reference.

### TECHNICAL FIELD

The present invention relates to a multi bead type greentire manufacturing apparatus, and more particularly, to a multi bead type greentire manufacturing apparatus, including a rubber plate made of a raw material of the greentire and mounted on a winding drum, and a plurality of gloves and bladders formed separately to transform the rubber plate, thereby automating a manufacturing process of a large-scale greentire having multi-layer beads.

### BACKGROUND ART

A manufacturing method of tires made of rubber differs depending on the type of tire, but generally includes: a forming process of preparing a raw material in a plate or ribbon shape and winding the raw material on a drum to form the basic shape of a tire; and a vulcanization process of placing the raw material wound on the drum in a mold and applying heat and pressure to complete the shape of the tire and provide elasticity to the tire.

A greentire is a semi-finished product obtained through a forming process, and has the basic shape of a tire as shown in FIG. 1. As shown in FIG. 1, a plurality of beads 95 which are reinforced cores made of steel wire are embedded in both end portions of the greentire.

FIG. 2 is a structure diagram of a greentire manufacturing apparatus according to a prior art. As shown in FIG. 2, the conventional greentire manufacturing apparatus is a cylindrical apparatus on which attachments, such as bladders 40 and gloves 30, are mounted. A rubber plate 91, which is a raw material, is wound on the outer circumferential surface of the cylindrical apparatus and is transformed and compressed to be formed into a greentire.

In other words, as shown in FIG. 2, the conventional greentire manufacturing apparatus includes: a winding drum 10 having a central portion on which the rubber plate 91 is wound; a plurality of bladders 40 respectively mounted at both side end portions of the drum to expand and contract the bladders by liquid pressure. Additionally, the bladders 40 are ring-shaped pockets surrounding the winding drum 10. The apparatus further includes a plurality of gloves 30 radially arranged on a central shaft of the winding drum 10 at the front end of the bladders 40, and thus, the greentire in which the beads 95 are embedded is formed as shown in FIG. 3.

In the conventional greentire manufacturing apparatus illustrated in FIG. 2, the winding drum 10 is divided into two portions, and an inner drum 20 is joined inside the winding drum 10, to expand and contract the entire cylindrical body of the winding drum while the divided winding drums 10 disposed at both sides of the inner drum 20 are gradually separate and contract in an axial direction. As shown in FIG. 3, a spiral shaft 25 is disposed concentrically with the winding drum 10 and the inner drum 20 is joined to a conveying nut 19 connected to the winding drum 10. Additionally, a motor 27 is connected to one end of the spiral shaft 25. Accordingly, when the motor 27 rotates, the divided winding drums 10 gradually separate or contract while the conveying nut 19 moves along the spiral shaft 25. Such an axial movement of the winding drum 10 may be applied to various devices capable of performing rectilinear movement, such as racks and pinions, hydraulic cylinders, pneumatic cylinders, and the like.

FIG. 3 illustrates a process of forming a greentire using the conventional greentire manufacturing apparatus.

As shown in the upper figure of FIG. 3, the rubber plate 91, which is the raw material, and the plurality of beads 95 are wound onto the outer circumferential surface of the winding drum 10 when the divided winding drums 10 are spaced apart from each other. Furthermore, when the spiral shaft 25 is rotated by the motor 27, the conveying nut 19 moves, and thus, the divided winding drums 10 contract, and the rubber plate 91 is transformed and the outer diameter of the wound rubber plate 91 is expanded. At the same time, the glove 30, which is received in the winding drum 10 directly below the beads 95, protrudes outwardly and presses and supports the inner circumferential surface of the wound rubber plate 91. Furthermore, a part of the rubber plate 91 wound onto the surface of the bladder 40 folds over the beads 95 by the expansion of bladder 40, thereby forming the greentire.

As shown in FIG. 3, the glove 30 pressing and supporting the beads 95 during the expansion and transformation process of the rubber plate 91 is connected with an expansion actuator 39 embedded in the winding drum 10 and protrudes outwardly from the winding drum 10 or is extended into the winding drum 10 when the expansion actuator 39 is expanded or contracted. The bladder 40 is mounted on the outer circumferential surface of the side end portion of the winding drum 10 and is expanded or contracted according to transfer and suction of working fluid, such as compressed air.

Moreover, as shown in FIG. 3, the protrusion and extension of the glove 30 corresponds to the expansion and contraction of the expansion actuator 39 connected to the lower end of the glove 30. In particular, the expansion actuator 39 may be one of various devices capable of performing rectilinear movement, such as racks and pinions, hydraulic cylinders, pneumatic cylinders, and on the like. In FIG. 3, the glove 30 and the expansion actuator 39 are directly connected with each other, however, the expansion actuator 39 may be mounted in parallel with the winding drum 10 and the expansion actuator 39 and the glove 30 may be connected with each other via a link member.

In general, small-sized tires, such as tires for cars, have beads 95 embedded in both side end portions thereof one by one, and thus, the greentire also has the beads 95 in both sides thereof one by one. However, large-sized tires, such as tires for full-sized cars or heavy equipment, including multiple clusters of beads 95 embedded therein, and thus, large-sized greentires are manufactured with multiple beads 95.

FIG. 4 is an exemplary sectional view showing a comparison of a large-sized greentire having the multiple beads 95 with a small-sized greentire. In FIG. 4, the small-sized greentire has beads 95 inserted into both sides of the tire one by one, and the large-sized greentire has at least two clusters of beads 95 embedded in each of the sides of the tire.

As shown in the magnified part of FIG. 4, the clusters beads 95 are inserted into multiple rubber plate layers. The rubber plates are laminated in multiple layers and the beads 95 are arranged between the layers of the multi-layer rubber plates 91, and thus, the greentire having the multi-layer structure of the rubber plates 91 and the beads 95 cannot be formed by the conventional greentire manufacturing apparatus illustrated in FIGS. 2 and 3.

To form the greentire having the multi-layer structure of the beads 95 and the rubber plates 91 as shown in the magnified part of FIG. 4 using the conventional greentire manufacturing apparatus, the rubber plates 91 and the beads 95 may be repeatedly wound on a winding part of the greentire manufacturing apparatus to form the multi-layer structure, and the gloves 30 and the bladders 40 may be operated to transform the laminated body of the rubber plates 91. However, it may be difficult to sufficiently press the multi-layer rubber plates 91 because the multi-layer rubber plates 91 are transformed simultaneously thereby loosening a contact between contact surfaces of each layer, decreasing adherence between the beads 95 and the rubber plates 91, and limiting the pressing force applied by the bladders 40 to the rubber plate 91.

Alternatively, a single thick rubber plate 91 and a single bead 95 with a large diameter may be used in place of the multi-layer rubber plates 91 and the multi-layer beads 95. However, this method may cause difficulty in transforming the thick rubber plate 91 by the bladder 40 and the diameter and the wire density of a steel wire component constituting the bead 95 may be increased when the large-diameter single bead 95 is used. Therefore, durability and tire safety may decrease since an excessive friction force is generated due to a repeated transformation of the bead 95 while the tire is used and it is difficult to discharge out the generated friction heat may not be completely discharged.

Accordingly, as shown in FIG. 5, the large-sized greentire having the multi-later rubber plates 91 and the multi-layer beads 95 is formed manually using a manually operated drum 15. In other words, as shown in FIG. 5, an inner layer rubber plate 92 and an outer layer rubber plate 93 are wound onto the outer circumferential surface of the manually operated drum 15, having a shape similar to an inner portion of the greentire to be formed. Furthermore, side end portions of the inner layer rubber plate 92 and the outer layer rubber plate 93, which are wound on the drum 15 are folded toward the center of the manually operated drum 15. Additionally, when a bead 95 is in contact with at a particular position on the surface of the outer layer rubber plate 93, the outer layer rubber plate 93 is folded up to closely surround the bead 95. When a second bead 95 is in contact with the particular position, the inner layer rubber plate 92 is folded up to closely surround the second bead 95, thereby completing the multi-layer structure of the greentire.

As described above, the greentire having the conventional multi-layer structure of the beads 95 is generally manufactured manually, and thus, the conventional greentire manufacturing apparatus may require highly skilled specialists. Particularly, uniformity of the greentire may not be maintained when the conventional method is applied to large scale manufacturing and distortion or delamination of the laminated body may occur. Furthermore, unnecessary air layers may be formed during the process of manually transforming the inner layer rubber plate 92 and the outer layer rubber plate 93 which are laminated, thereby causing faults on the finished tire.

### SUMMARY

Accordingly, the present invention provides a multi bead type greentire manufacturing apparatus which may automate a process of forming a large-sized greentire having a multi-layer structure of beads.

In particular, the present invention provides a multi bead type greentire manufacturing apparatus which includes: a winding drum (10) having a central portion on which a rubber plate (91) is wound; a bladder (40) mounted at a side end portion of the winding drum (10) as a ring-shaped pocket surrounding the winding drum (10), wherein the bladder (40) is expandable and contractible corresponding to fluid pressure; and a glove (30) protruding from a central shaft of the winding drum (10) inside the winding drum (10) near the front end side of the bladder (40), to allow the glove (30) and the bladder (40) to transform and compress the rubber plate (91) wound on the winding drum (10). Additionally, the multi bead type greentire manufacturing apparatus includes an inner bladder (41) mounted at the side end portion of the winding drum (10); an inner glove (31) disposed at the central portion of the winding drum (10) and an outer glove (32) disposed on the inner bladder (41). The outer and inner gloves are formed by dividing the glove (30) inside the winding drum (10) at the front end side of the inner bladder (41). Additionally, the inner glove (31) and the outer glove (32) protrude outwardly from the winding drum (10) and extend into the winding drum (10). Furthermore, the apparatus includes an outer bladder (42) as a ring-shaped pocket mounted outside the inner bladder (41) concentrically with the winding drum (10), the outer bladder (42) disposed in an axial direction of the winding drum (10).

The multi bead type greentire manufacturing apparatus according to the present invention may automate the process of manufacturing the large-sized greentire having the multi-layer structure of the beads, to increase the productivity of the large-sized greentires and reduce an error rate in forming the greentires by increasing accuracy in the forming process.

Moreover, the multi bead type greentire manufacturing apparatus according to the present invention may form the greentires of the multi-layer structure in various structures by using various types of rubber plates 91 having different properties.

Additionally, the multi bead type greentire manufacturing apparatus according to the present invention may increase the adherence between the components mounted inside the tire through a multi-layered distribution of the beads in the greentire and may increase durability of the finished tire through effective dispersion and discharge of friction heat of the beads.

### BRIEF DESCRIPTION OF THE DRAWINGS

The above and other objects, features and advantages of the present invention will be apparent from the following description of the exemplary embodiments of the invention in conjunction with the accompanying drawings, in which:

FIG. 1 is an exemplary view of a portion of a greentire, according to a prior art;

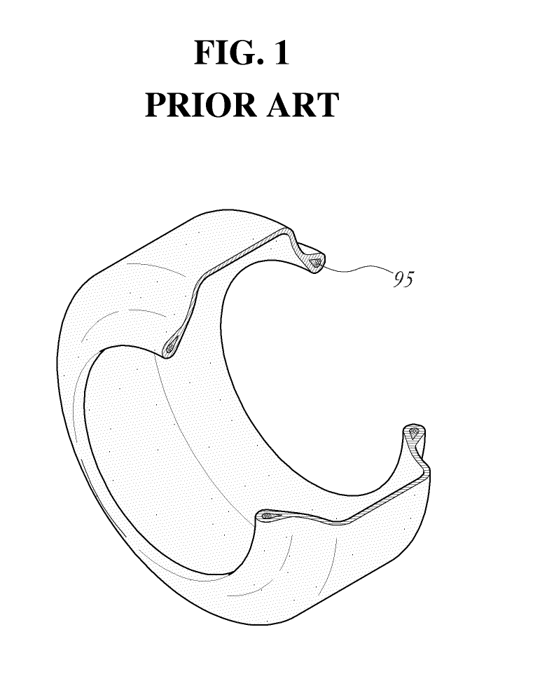

FIG. 2 is an exemplary diagram of a single bead type greentire manufacturing apparatus according to the prior art;

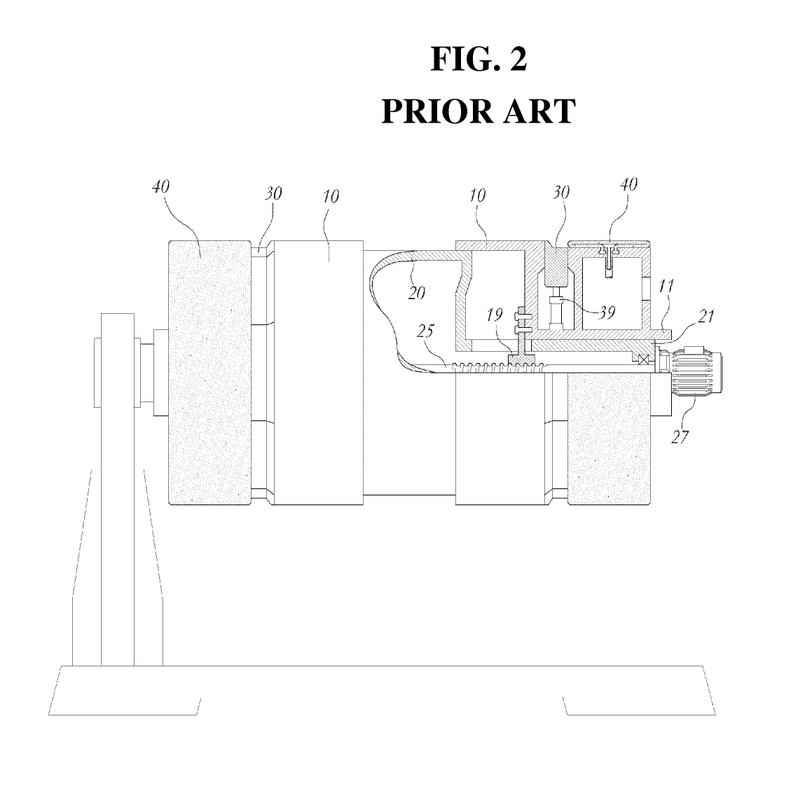

FIG. 3 is an exemplary partial sectional view showing a used state of the single bead type greentire manufacturing apparatus according to the prior art;

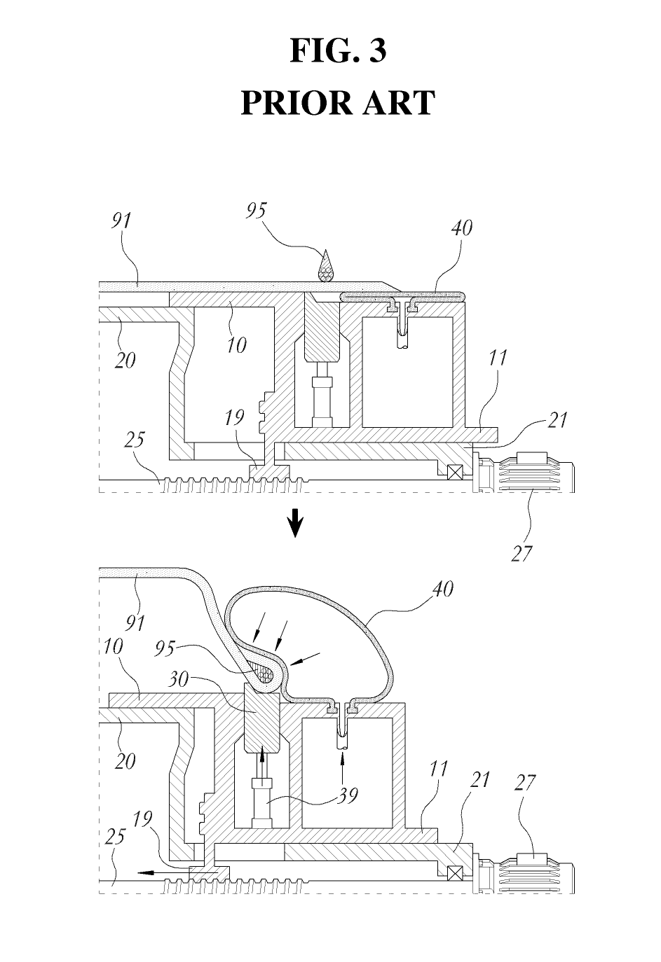

FIG. 4 is an exemplary sectional view showing a single bead type greentire and a multi bead type greentire, according to the prior art;

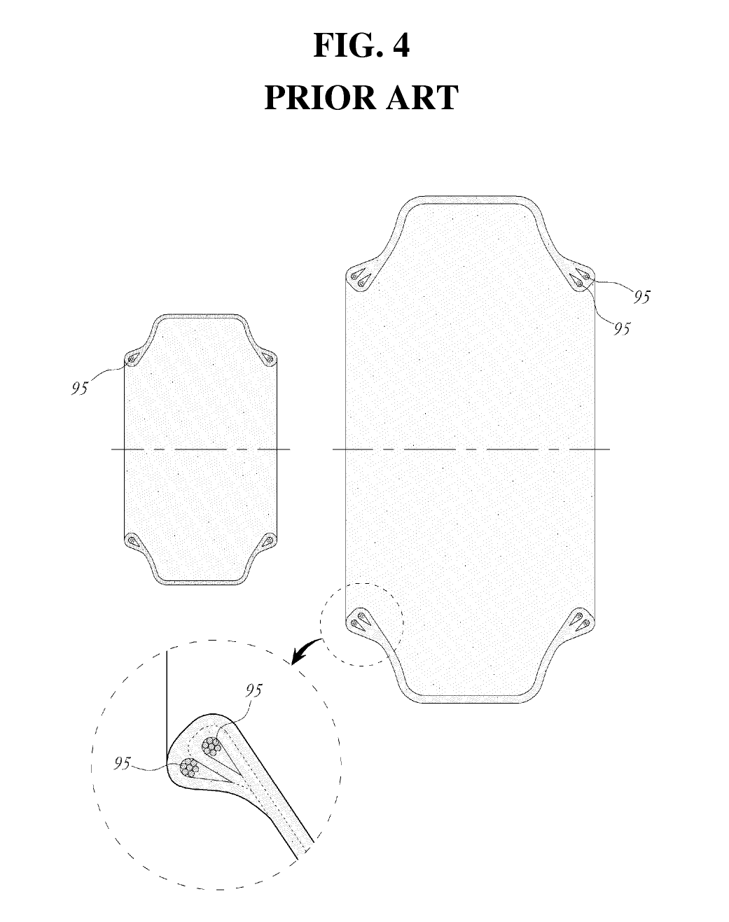

FIG. 5 is an exemplary view of a conventional manufacturing method of the multi bead type greentire, according to the prior art;

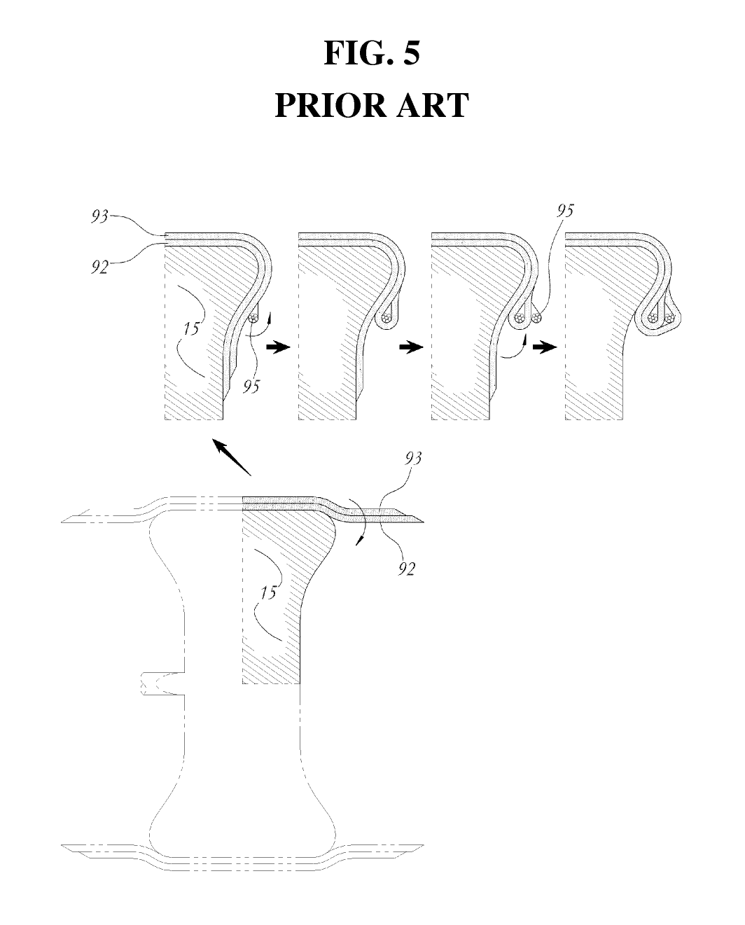

FIG. 6 is an exemplary view of a multi bead type greentire manufacturing apparatus according to an exemplary embodiment of the present invention;

FIG. 7 is an exemplary sectional view of the multi bead type greentire manufacturing apparatus according to an exemplary embodiment of the present invention;

FIG. 8 is an exemplary partial sectional view of the multi bead type greentire manufacturing apparatus according to an exemplary embodiment of the present invention;

FIG. 9 is an exemplary sectional view along the line of A-A′ of FIG. 7, according to an exemplary embodiment of the present invention;

FIG. 10 is an exemplary view of a material winding method according to an exemplary embodiment of the present invention;

FIG. 11 is an exemplary view of an operational process of the multi bead type greentire manufacturing apparatus according to an exemplary embodiment of the present invention; and

FIG. 12 is an exemplary partial view of a multi bead type greentire manufactured through the multi bead type greentire manufacturing apparatus according to an exemplary embodiment of the present invention.

### DETAILED DESCRIPTION OF EXEMPLARY EMBODIMENTS

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Reference will be now made in detail to the exemplary embodiment of the present invention with reference to the accompanying drawings.

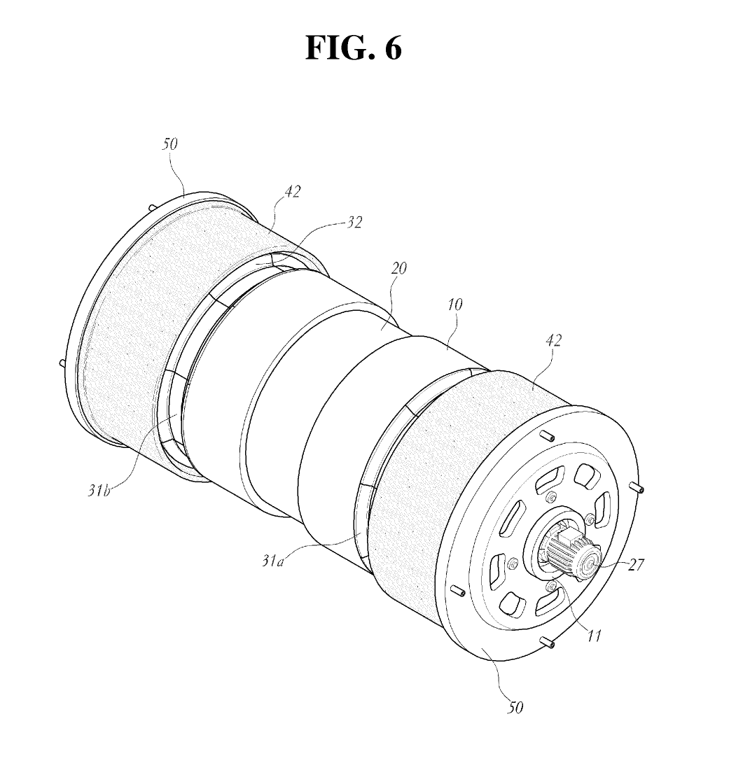

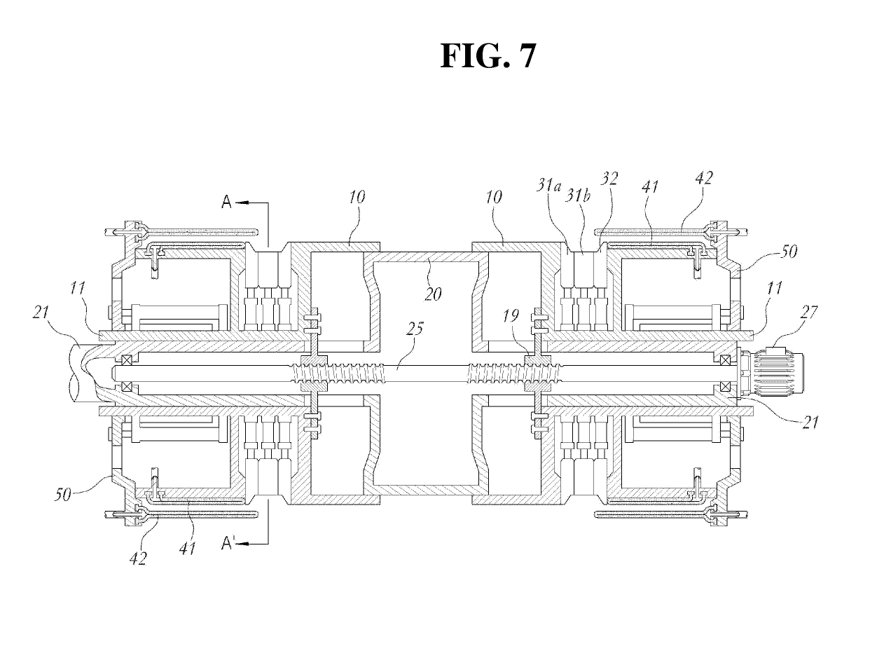

FIG. 6 is an exemplary view showing the outward appearance of a multi bead type greentire manufacturing apparatus according to the present invention, and FIG. 7 is an exemplary sectional view of the multi bead type greentire manufacturing apparatus. As shown in FIGS. 6 and 7, the multi bead type greentire manufacturing apparatus according to the present invention may include: a winding drum 10 on which a rubber plate 91 is wound at a central portion thereof; an inner bladder 41 and an outer bladder 42 formed as ring-shaped pockets and mounted around both side end portions of the winding drum 10, wherein the inner and outer bladders are expandable and contractible by fluid pressure; and a plurality of inner gloves 31 and outer gloves 32 mounted inside the winding drum 10 at a front end side of the inner bladder 41, wherein the inner gloves 31 and outer gloves 32 protrude radially from a central shaft of the winding drum 10.

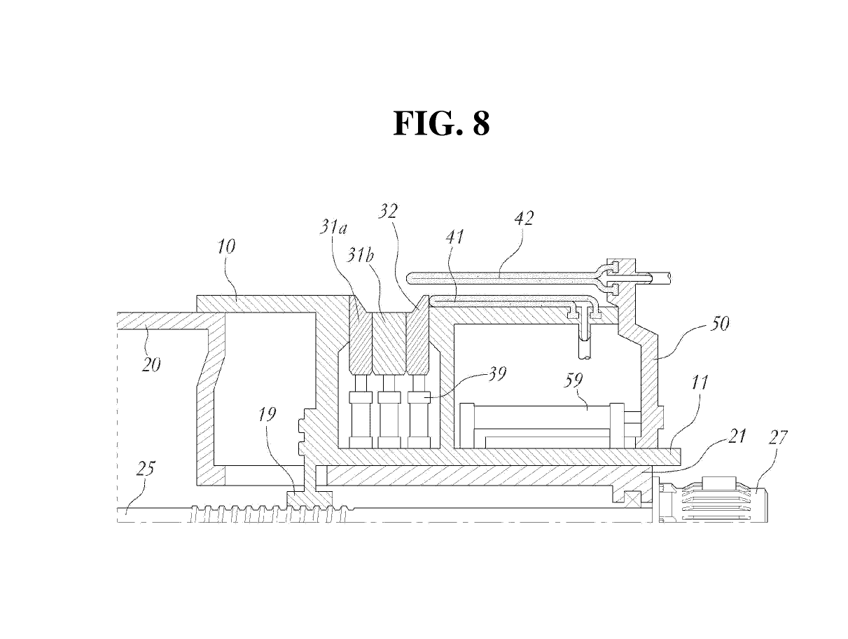

In other words, as shown in FIG. 7, the entire cylindrical bodies including the winding drum 10 are joined concentrically and have horizontal and bilateral symmetry relative to the central shaft. In addition, the tire manufacturing apparatus is partially illustrated in FIG. 8, excluding the parts in symmetry in a longitudinal section.

As shown in FIGS. 6 to 8, the winding drum 10 may be divided into two parts, and an inner drum 20 may be mounted inside the winding drum 10, to allow the entire cylindrical body of the winding drum to expand and contract. In other words, the divided winding drums 10 disposed at both sides of the inner drum 20 may be gradually separated and gradually contracted toward each other in an axial direction. As shown in FIGS. 7 and 8, a spiral shaft 25 arranged concentrically with the winding drum 10 and the inner drum 20 may be connected to communicate with a conveying nut 19 connected to the winding drum 10, and a motor 27 may be connected to one end of the spiral shaft 25. Accordingly, when the motor 27 rotates, the divided winding drums 10 are gradually separated and gradually contracted toward each other as the conveying nut 19 moves along the rotating spiral shaft 25. Such an axial movement of the winding drum 10 may be applied to various devices performing rectilinear movement, such as racks and pinions, hydraulic cylinders, pneumatic cylinders, and the like.

In other words, as shown in FIG. 8, an outer hollow shaft 11 formed concentrically with the winding drum 10 may be disposed at the central portion of the winding drum 10, and a plurality of inner hollow shafts 21 formed concentrically with the winding drum 10 and the inner drum 20 may be respectively disposed at both sides of the central portion of the inner drum 20. In addition, the outer circumferential surface of the inner drum 20 maintains contact with the inner circumferential surface of the winding drum 10 as the inner drum moves, to join the inner hollow shaft 21 to the outer hollow shaft 11. The spiral shaft 25 which rotates by a motor 27 may be mounted at the central portion of the inner hollow shaft 21, and thus, when the spiral shaft 25 rotates, the conveying nut 19 moves in an axial direction of the spiral shaft 25.

Moreover, an inner bladder 41 and an outer bladder 42 may expand and contract according to transfer or suction of working fluid, such as compressed air, and are mounted concentrically with the winding drum 10 at the side end portion of the winding drum 10. As shown in FIG. 8, the outer bladder 42 may be spaced from an exterior side of the inner bladder 41 to surround the inner bladder 41, and the outer bladder 42 may be mounted on a reciprocating bar 50 joined to the outer hollow shaft 11 at the side end of the winding drum 10. Furthermore, a reciprocating actuator 59 configured to perform rectilinear movement, such as hydraulic cylinders or pneumatic cylinders, may be connected to the reciprocating bar 50, to move the reciprocating bar 50 and the outer bladder 42 in the axial direction of the winding drum 10 when the reciprocating actuator 59 is expanded or contracted.

As shown in FIGS. 7 and 8, an inner glove 31 may be disposed at the middle side of the winding drum 10 of the front end side of the inner bladder 41, and an outer glove 32 may be disposed at the inner bladder side. The inner glove 31 and the outer glove 32 may be separately protruding from the winding drum 10 or may extend into the winding drum 10. The inner glove 31 may be driven by a plurality of expansion actuators 39 connected to the inner glove 31, and the outer glove 32 may be driven by the expansion actuators 39 connected to the outer glove 32.

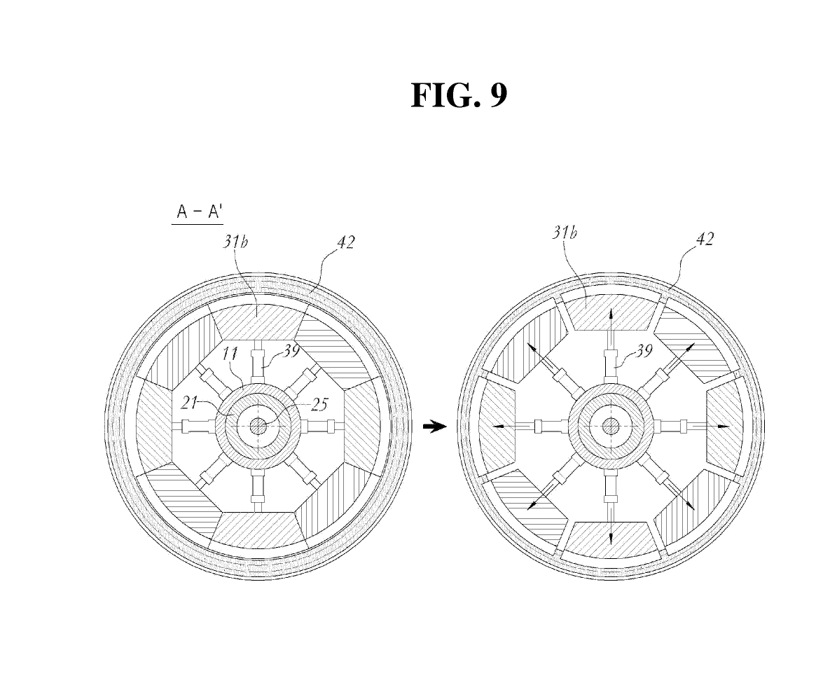

FIG. 9 is a sectional view taken along the line of A-A′ of FIG. 7. As shown in FIG. 9, disc bodies of the outer glove 32 and the inner glove 31 may be divided at substantially equal angles and radially arranged on the central shaft of the winding drum 10, and thus, the diameters of assemblies of the outer glove 32 and the inner glove 31 may be respectively increased or decreased according to the expansion and contraction of the expansion actuators 39.

Moreover, as shown in the drawings, the inner glove 31 may be divided into two portions, and may include a first inner glove 31a disposed at the middle side of the winding drum 10 and a second inner glove 31b disposed near the outer glove 32, wherein the first inner glove 31a and the second inner glove 31b may be separately driven by the expansion actuators 39 connected thereto. However, the first and the second inner gloves 31a and 31b may manage the inner glove 31 according to standards and materials of the greentire to be formed. In other words, when a small-sized or simple structure greentire is to be formed, the first and the second inner gloves 31a and 31b may be combined to form one inner glove.

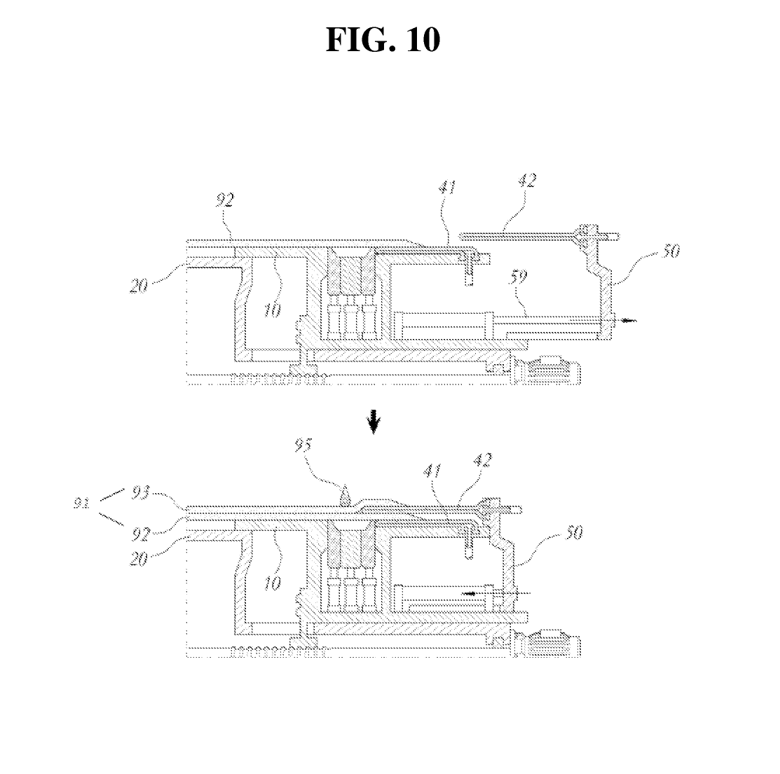

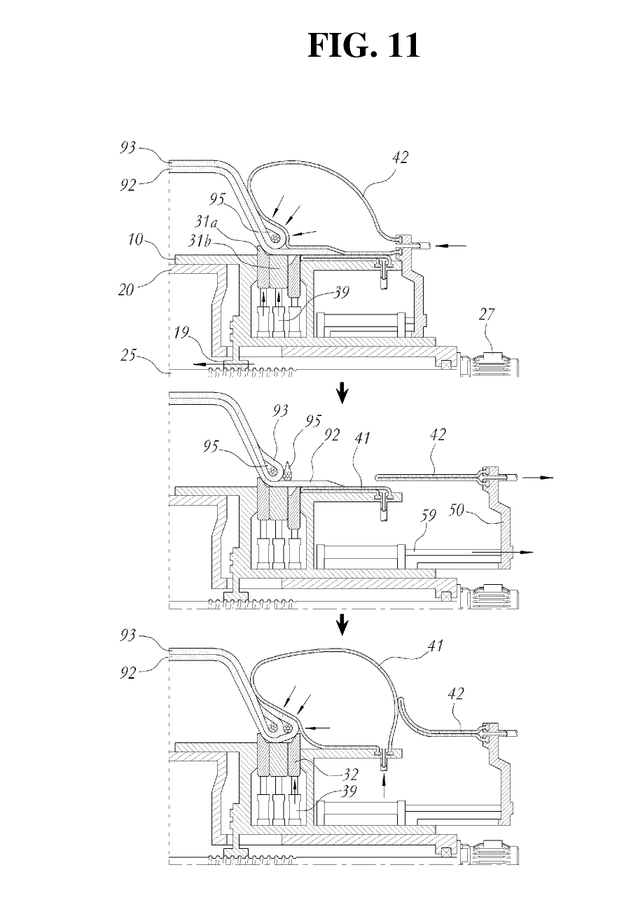

FIGS. 10 and 11 illustrate a process of forming the greentire using the inner layer rubber plate 92, the beads 95, and the outer layer rubber plate 93 of the multi bead type greentire manufacturing apparatus according to an exemplary embodiment of the present invention.

First, FIG. 10 illustrates a process of winding the inner layer rubber plate 92 and the outer layer rubber plate 93, which are raw materials of the greentire, onto the outer circumferential surface of the winding drum 10. In the upper figure of FIG. 10, the reciprocating actuator 59 may be expanded, thereby moving the outer bladder 42 to expose the inner bladder 41. Furthermore, once the inner bladder 41 is exposed, the inner layer rubber plate 92 may be wound onto the outer circumferential surface of the winding drum 10 and onto the surface of the inner bladder 41. After the inner layer rubber plate 92 is wound onto the winding drum 10, as shown in the lower figure of FIG. 10, the reciprocating actuator 59 may be contracted to laminate the outer bladder 42 onto the surface of the inner layer rubber plate 92, and the outer layer rubber plate 93 may be wound onto the surface of the inner layer rubber plate 92 and onto the surface of the outer bladder 42. Furthermore, the plurality of beads 95 may be mounted on the outer circumferential surface of the wound outer layer rubber plate 93.

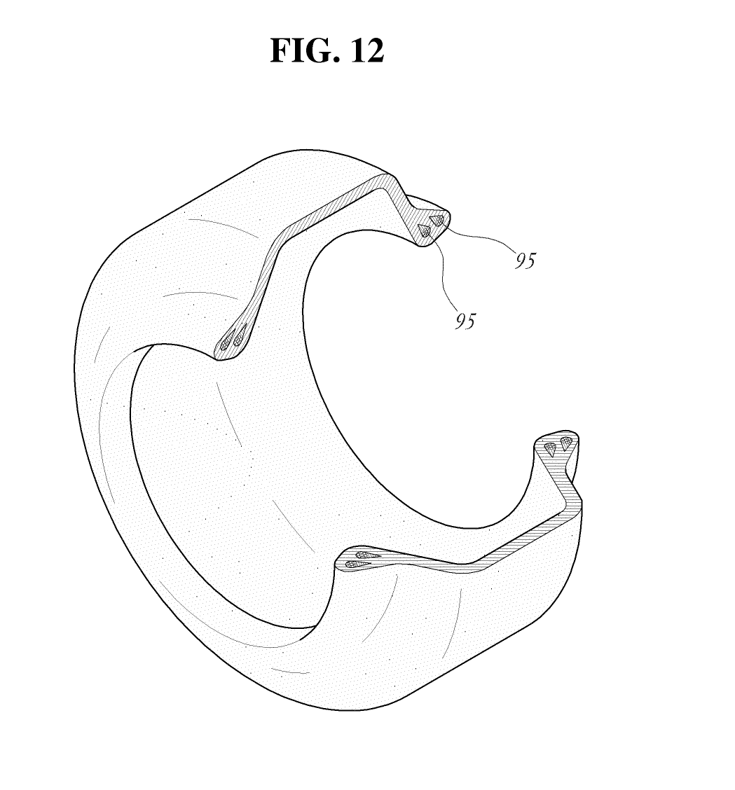

Through the above process, when the raw materials of the greentire are mounted on the greentire manufacturing apparatus, the greentire may be formed, as shown in FIG. 12, through the automated process illustrated in FIG. 11.

The upper figure of FIG. 11, shows the forming process of the greentire of the multi-layer bead structure according to the present invention. When the spiral shaft 25 is rotated to move the conveying nut 19, the laminated body of the inner layer rubber plate 92 and the outer layer rubber plate 93 may be transformed and the outer diameter of the laminated body may be expanded while the winding drums 10 contract toward each other, and simultaneously, the inner glove 31, disposed in the winding drum 10 below the beads 95, protrudes outwardly and presses and supports the inner circumferential surface of the wound inner layer rubber plate 92. Additionally, a part of the outer layer rubber plate 93 wound on the surface of the outer bladder 42 may fold around the plurality of beads 95 as a reciprocating actuator 39 and the outer bladder expand.

Moreover, as shown in the middle figure of FIG. 11, when the working fluid of the outer bladder 42 is suctioned, the outer bladder 42 is contracted and the reciprocating actuator 39 expands, thereby moving reciprocating bar 50 and the outer bladder 42 to expose the inner bladder 41. In response the movement of the reciprocating actuator 39 and the transfer of the working fluid to the inner bladder 41, thereby expanding the inner bladder 41, the exposed inner rubber layer plate 92 may fold over the beads 95. Furthermore, the beads 95 may be substantially closely mounted on the surface of the outer layer rubber plate 93 surrounding the existing beads 95.

As described above, the multi bead type greentire manufacturing apparatus according to the present invention may automate the manufacturing process of the large-sized greentire having the multi-layer bead structure, and may thus, increase the productivity of the large-sized greentires and reduce an error rate in forming the greentires by securing accuracy in forming.

What is claimed is:

1. A multi bead type greentire manufacturing apparatus, including:
a winding drum having a central portion on which a rubber plate is wound;
a bladder mounted at a side end portion of the winding drum as a ring-shaped pocket, wherein the bladder is expandable and contractible by fluid pressure; and
a glove protruding radially from a central shaft of the winding drum near a front end side of the bladder, to transform the glove and the bladder and compress the rubber plate wound on the winding drum.

2. The multi bead type greentire manufacturing apparatus of claim 1, further comprising:
an inner bladder mounted at the side end portion of the winding drum;
an inner glove disposed at the central portion of the winding drum;
an outer glove disposed on the inner bladder, wherein the inner and the outer gloves are formed by dividing the glove inside the winding drum at a front end side of the inner bladder; and
an outer bladder having a ring shaped pocket, wherein the outer bladder is mounted in the winding drum and spaced from an exterior side of the inner bladder.

3. The multi bead type greentire manufacturing apparatus of claim 2, wherein the inner glove and the outer glove protrude from the winding drum and are separately received into the winding drum.
